(19) United States
(12) Patent Application Publication
(10) Pub. No.: US 2026/0273409 A1
(43) Pub. Date: Sep. 17, 2026

(54) METHOD AND APPARATUS FOR USING VIRTUAL THROWABLE ITEM, DEVICE, AND STORAGE MEDIUM

(71) Applicant: Tencent Technology (Shenzhen) Company Limited, Shenzhen (CN)

(72) Inventor: Jingjing HE, Shenzhen (CN)

(21) Appl. No.: 19/671,015

(22) Filed: May 7, 2026

Related U.S. Application Data
(63) Continuation of application No. PCT/CN2025/081526, filed on Mar. 10, 2025.

(30) Foreign Application Priority Data
Apr. 26, 2024 (CN) 202410522054.8

(51) Int. Cl. A63F 13/55; A63F 13/533; A63F 13/5375; A63F 13/837

(52) U.S. Cl. CPC A63F 13/55; A63F 13/533; A63F 13/5375; A63F 13/837

(57) ABSTRACT

This application discloses a method for operating a virtual throwable item in a virtual environment performed by a computer device. The method includes: displaying a first virtual object and a release control of a virtual throwable item; displaying an auxiliary control of the virtual throwable item in response to a pre-trigger operation for the release control; changing an aiming direction of the virtual throwable item from a first direction to a second direction in response to a first trigger operation for the auxiliary control, the second direction being a direction from the first virtual object to a second virtual object in the virtual environment; and causing the first virtual object to throw the virtual throwable item in the second direction in response to a second trigger operation for the release control.

### CROSS-REFERENCE TO RELATED APPLICATIONS

This application is a continuation application of PCT Patent Application No. PCT/CN2025/081526, entitled “METHOD AND APPARATUS FOR USING VIRTUAL THROWABLE ITEM, DEVICE, AND STORAGE MEDIUM” filed on Mar. 10, 2025, which claims priority to Chinese Patent Application No. 202410522054.8, entitled “METHOD AND APPARATUS FOR USING VIRTUAL THROWABLE ITEM, DEVICE, AND STORAGE MEDIUM” filed with the China National Intellectual Property Administration on Apr. 26, 2024, all of which are incorporated herein by reference in their entirety.

### FIELD OF THE TECHNOLOGY

Embodiments of this application relate to the technical field of human-computer interactions, and to a method and apparatus for using a virtual throwable item, a device, and a storage medium.

### BACKGROUND OF THE DISCLOSURE

An application program such as a game provides a virtual environment. In the virtual environment, a virtual object usually needs to be controlled to perform activities in the virtual environment, such as walking, driving, climbing, picking up items, and battling.

In the related art, when a virtual throwable item is used, the virtual object holding the virtual throwable item needs to be moved, or a viewing angle of the virtual object needs to be adjusted, to adjust an aiming direction of the virtual throwable item.

However, novice players may be inaccurate in operations such as adjusting the viewing angle or moving locations, requiring multiple fine adjustments, which results in low human-computer interaction efficiency. In addition, inaccurate operations may cause the virtual throwable item to aim at another virtual object by mistake on which a virtual item effect fails.

### SUMMARY

This application provides a method and apparatus for using a virtual throwable item, a device, and a storage medium. Technical solutions are implemented as follows:

According to an aspect of this application, a method for operating a virtual throwable item in a virtual environment performed by a computer device, and the method including:
displaying a first virtual object and a release control of a virtual throwable item;
displaying an auxiliary control of the virtual throwable item in response to a pre-trigger operation for the release control;
changing an aiming direction of the virtual throwable item from a first direction to a second direction in response to a first trigger operation for the auxiliary control, the second direction being a direction from the first virtual object to a second virtual object in the virtual environment; and
causing the first virtual object to throw the virtual throwable item in the second direction in response to a second trigger operation for the release control.

According to another aspect of this application, a computer device is provided, including a processor and a memory, the memory having at least one section of computer program stored therein, and the at least one section of computer program being loaded and executed by the processor to implement the method for operating the virtual throwable item in the virtual environment as described in the above aspects.

According to another aspect of this application, a non-transitory computer-readable storage medium is provided, the readable storage medium having at least one section of computer program stored therein, and the at least one section of computer program being loaded and executed by a processor of a computer device and causing the computer device to implement the method for operating the virtual throwable item in the virtual environment as described in the above aspects.

Beneficial effects brought by the technical solutions provided in this application at least include:

The first virtual object and the release control of the virtual throwable item in the virtual environment are displayed, and the first virtual object carries the virtual throwable item. When the virtual throwable item needs to be used, the pre-trigger operation may be performed on the release control to display that the virtual throwable item is in the ready-to-throw state in response to the pre-trigger operation for the release control. The auxiliary control is displayed when the virtual throwable item is in the ready-to-throw state, to provide a functional entry for quickly adjusting the aiming direction of the virtual throwable item. Next, if the aiming direction of the virtual throwable item needs to be adjusted to aim at the second virtual object, the first trigger operation may be performed only on the auxiliary control, so that in response to the first trigger operation for the auxiliary control, the aiming direction of the virtual throwable item is quickly adjusted to the second direction pointing to the second virtual object, without requiring another operation, and in response to the second trigger operation for the release control, throwing the virtual throwable item in the second direction is displayed, to enable the virtual throwable item to act on the second virtual object. In this application, the auxiliary control provides the functional entry for quickly adjusting the aiming direction of the virtual throwable item. First, this significantly improves the human-computer interaction efficiency, which was hindered by an inaccurate operation of a novice player for adjusting a viewing angle or moving a location that often requires multiple fine adjustments, when the aiming direction is adjusted by adjusting the viewing angle or moving the location in the related art; and second, this avoids incorrect aiming of the virtual throwable item at another virtual object on which the virtual item effect fails, thereby significantly improving the interaction between an end user and the graphical user interface of the virtual environment.

### BRIEF DESCRIPTION OF THE DRAWINGS

To describe technical solutions of the embodiments of this application more clearly, the accompanying drawings required for describing the embodiments are introduced briefly below. The accompanying drawings in the following description show only some embodiments of this application, and a person of ordinary skill in the art may still derive other accompanying drawings from these accompanying drawings without creative efforts.

FIG. 1 is a schematic diagram of a computer system according to an exemplary embodiment of this application.

FIG. 2 is a schematic diagram of a method for using a throwable catching item according to an exemplary embodiment of this application.

FIG. 3 is a flowchart example 1 of a method for operating a virtual throwable item in a virtual environment according to an exemplary embodiment of this application.

FIG. 4 is a flowchart example 2 of a method for operating a virtual throwable item in a virtual environment according to an exemplary embodiment of this application.

FIG. 5 is a schematic diagram of a candidate virtual object according to an exemplary embodiment of this application.

FIG. 6 is a flowchart example 3 of a method for operating a virtual throwable item in a virtual environment according to an exemplary embodiment of this application.

FIG. 7 is a schematic diagram of a virtual environment according to an exemplary embodiment of this application.

FIG. 8 is a flowchart example 4 of a method for operating a virtual throwable item in a virtual environment according to an exemplary embodiment of this application.

FIG. 9 is a schematic diagram of a virtual environment according to an exemplary embodiment of this application.

FIG. 10 is a schematic diagram of a candidate virtual object according to an exemplary embodiment of this application.

FIG. 11 is a flowchart example 5 of a method for operating a virtual throwable item in a virtual environment according to an exemplary embodiment of this application.

FIG. 12 is a structural block diagram of an apparatus for using a virtual throwable item according to an exemplary embodiment of this application.

FIG. 13 is a structural block diagram of a terminal according to an exemplary embodiment of this application.

Accompanying drawings herein are incorporated into the specification and constitute a part of this specification, show embodiments that conform to this application, and are used for explaining the principle of this application together with this specification.

### DESCRIPTION OF EMBODIMENTS

To make the objectives, technical solutions, and advantages of this application clearer, the following further describes implementations of this application in detail with reference to the accompanying drawings.

Exemplary embodiments may be described in detail herein, and examples of the exemplary embodiments are shown in accompanying drawings. When the following description involves the accompanying drawings, unless otherwise indicated, same numerals in different accompanying drawings represent the same or similar elements. The implementations described in the following exemplary embodiments do not represent all implementations consistent with this application. On the contrary, the implementations are only examples of apparatuses and methods consistent with some aspects of this application as claimed in claims.

Terms used in this application are merely intended to describe the specific embodiments but are not intended to limit this application. The singular forms of “a” and “the” used in this application and the appended claims are intended to include the plural forms as well unless the context clearly indicates otherwise. The term “and/or” used herein indicates and includes any or all combinations of one or more associated listed items.

User information (including, but not limited to, user equipment information, user personal information, and the like) and data (including, but not limited to, data for analysis, stored data, displayed data, and the like) involved in this application both are information and data that are authorized by a user or fully authorized by all parties. Collection, use, and processing of related data need to comply with relevant laws and regulations of relevant countries and regions. For example, a pre-trigger operation, a trigger operation, or the like involved in this application is acquired under full authorization.

Although terms such as “first” and “second” may be used in this application to describe various information, the information is not to be limited to these terms. These terms are merely used to differentiate the same type of information. For example, without departing from the scope of this application, a first parameter may further be referred to as a second parameter. Similarly, the second parameter may further be referred to as a first parameter. Depending on the context, for example, the word “if” used herein may be interpreted as “at” or “when”, or “in response to a determination”.

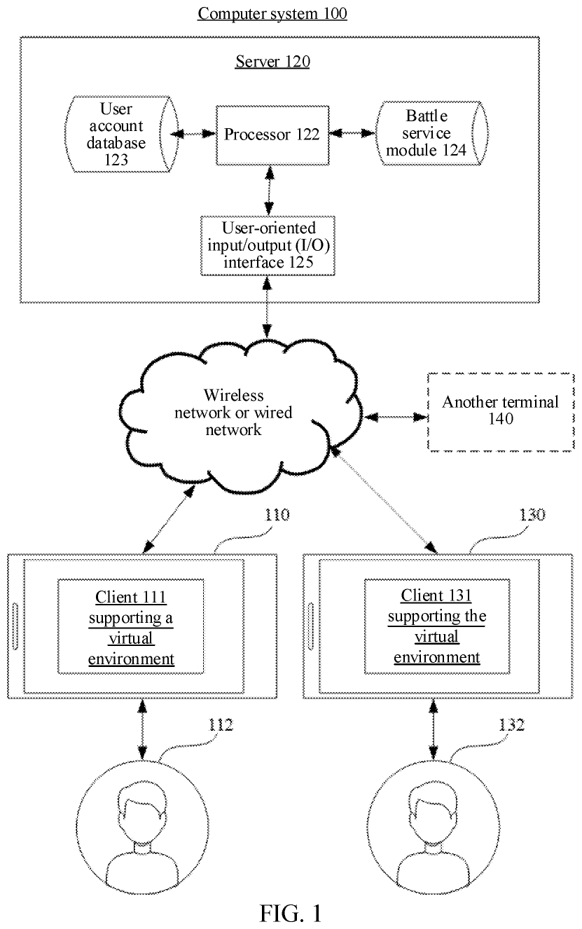

FIG. 1 is a structural block diagram of a computer system according to an exemplary embodiment of this application. A computer system 100 includes a first terminal 110, a server 120, and a second terminal 130.

The first terminal 110 runs a client 111 supporting a virtual environment, and the client 111 may be a multi-player online battle program. When the first terminal runs the client 111, a user interface of the client 111 is displayed on a screen of the first terminal 110. The client 111 may be any one of a battle royale shooting game, a virtual reality (VR) application, an augmented reality (AR) program, a three-dimensional map program, a virtual reality game, an augmented reality game, a casual game, a party game, a first-person shooting game (FPS), a third-person shooting game (TPS), a multi-player online battle arena game (MOBA), or a simulation game (SLG). In this embodiment, an example in which the client 111 is an FPS game is used for description. The first terminal 110 is a terminal used by a first user 112. The first user 112 uses the first terminal 110 to control a first virtual object located in the virtual environment to perform activities. The first virtual object may be referred to as a virtual object of the first user 112. Activities of the first virtual object include, but are not limited to, at least one of: moving, jumping, teleporting, skill casting, item using, body posture adjusting, crawling, walking, running, riding, flying, driving, picking up, shooting, attacking, or throwing. For example, the first virtual object may be a simulated human character or a cartoon character.

The second terminal 130 runs a client 131 supporting a virtual environment, and the client 131 may be a multi-player online battle program. When the second terminal 130 runs the client 131, a user interface of the client 131 is displayed on a screen of the second terminal 130. The client may be any one of a battle royale shooting game, a VR application, an AR program, a three-dimensional map program, a virtual reality game, an augmented reality game, FPS, TPS, MOBA, or SLG. In this embodiment, an example in which the client is an MOBA game is used for description. The second terminal 130 is a terminal used by a second user 132. The second user 132 uses the second terminal 130 to control a second virtual object located in the virtual environment. The second virtual object may be referred to as a virtual object of the second user 132. For example, the second virtual object may be a simulated human character or a cartoon character.

In some embodiments, the first virtual object and the second virtual object are in a same virtual environment. In some embodiments, the first virtual object and the second virtual object may belong to a same camp, a same team, a same organization, have a friendship, or have a temporary communication permission. In some embodiments, the first virtual object and the second virtual object may belong to different camps, different teams, different organizations, or have an adversarial relationship.

In some embodiments, the client installed on the first terminal 110 and the client installed on the second terminal 130 are the same, or the clients installed on the two terminals are clients of the same type on different operating system platforms (such as Android, or IOS). The first terminal 110 may refer to one of a plurality of terminals, and the second terminal 130 may refer to one of a plurality of terminals. In this embodiment, only the first terminal 110 and the second terminal 130 are used as an example for description. The first terminal 110 and the second terminal 130 are identical or different in device types. The device type includes: at least one of a smartphone, a tablet computer, an e-book reader, an MP3 player, an MP4 player, a laptop portable computer, and a desktop computer.

Only two terminals are shown in FIG. 1, but multiple other terminals 140 may access the server 120 in different embodiments. In some embodiments, one or more terminals 140 are further terminals corresponding to a developer. A development and editing platform of a client supporting a virtual environment is installed on the terminal 140. The developer may edit and update the client on the terminal 140, and transmit an updated client setup package to the server 120 over a wired or wireless network. The first terminal 110 and the second terminal 130 may download the client setup package from the server 120 to update the client.

The first terminal 110, the second terminal 130, and another terminal 140 are connected to the server 120 over a wireless network or a wired network.

The server 120 includes at least one of one server, a plurality of servers, a cloud computing platform, and a virtualization center. The server 120 is configured to provide a background service for a client supporting a three-dimensional virtual environment. In some embodiments, the server 120 takes on primary computational work, and the terminal takes on secondary computational work; or the server 120 takes on the secondary computational work, and the terminal takes on the primary computational work; or collaborative computation is performed by using a distributed computational architecture between the server 120 and the terminal.

For example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal 140, such as portraits of the user accounts, nicknames of the user accounts, fighting power indexes of the user accounts, and service areas of the user accounts. The battle service module 124 is configured to provide a plurality of battle rooms for the user to battle against each other, such as a 1V1 battle, a 3V3 battle, and a 5V5 battle. The user-oriented I/O interface 125 is configured to establish communication with the first terminal 110 and/or the second terminal 130 over a wireless network or a wired network for data exchange.

The method provided in this application may be applied to, but not limited to, at least one of the following scenarios: a virtual reality application program, a three-dimensional map program, a casual game, a party game, a first-person shooting (FPS) game, a third-person shooting (TPS) game, a multi-player online battle arena (MOBA) game, a multi-player gunfight survival game, and the like. The following embodiments are described by taking an application in a game as an example.

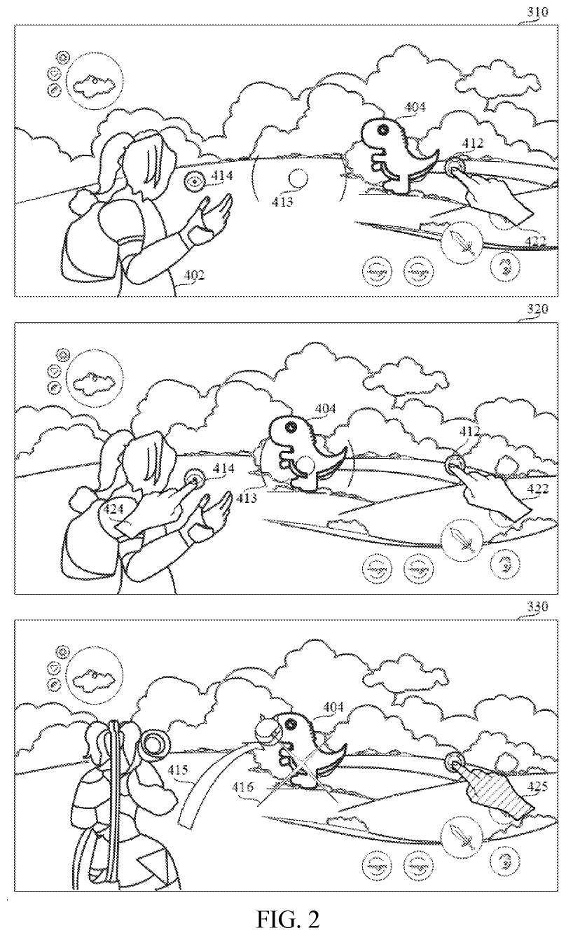

FIG. 2 is a schematic diagram of a method for using a throwable catching item according to an exemplary embodiment of this application.

In a first interface 310, a first virtual object 402 and a release control 412 of a throwable catching item are displayed; and the throwable catching item may be configured to catch a pet virtual object in the virtual environment. For example, in response to the fact that the throwable catching item comes into effect, ownership information of a pet virtual object within an effect range of the throwable catching item is changed to belonging to a thrower of the throwable catching item. The virtual environment further includes a pet virtual object 404, and the throwable catching item acts on the pet virtual object 404 to generate an item effect of catching.

In response to a press-and-hold operation 422 for the release control 412 of the throwable catching item, it is displayed that the first virtual object 402 raises an arm and prepares to throw the throwable catching item. This is in a ready-to-throw state. An aiming reticle 413 is displayed, the aiming reticle 413 indicates an aiming direction of a throwable catching item, and in the first interface, the aiming direction of the throwable catching item is a first direction. An auxiliary control 414 of the throwable catching item is displayed; and before a terminal receives the press-and-hold operation 422 for the release control 412 of the throwable catching item, the auxiliary control 414 is not displayed or is in an unavailable inactivated state.

In a second interface 320, the press-and-hold operation 422 for the release control 412 of the throwable catching item is maintained, and the ready-to-throw state is continued. In response to a click/tap operation 424 for the auxiliary control 414 of the throwable catching item, the aiming direction of the throwable catching item is changed from the first direction to a second direction, where the second direction points to a location of the pet virtual object 404, namely, the aiming reticle 413 aims at the pet virtual object 404.

In a third interface 330, in response to an operation 425 of no longer pressing and holding the release control 412 of the throwable catching item, throwing the throwable catching item toward the aimed pet virtual object 404 is displayed. The third interface 330 further displays a throwing trajectory 415 and an effect animation 416 of the throwable catching item.

In conclusion, the auxiliary control is displayed when the throwable catching item is in the ready-to-throw state, to provide a functional entry for quickly adjusting the aiming direction of the virtual throwable item. In response to a first trigger operation (such as the click/tap operation 424) for the auxiliary control, the aiming direction of the throwable catching item is quickly adjusted from the first direction to the second direction pointing to the pet virtual object 404. First, this avoids a problem of low human-computer interaction efficiency caused by an inaccurate operation of a novice player for adjusting a viewing angle or moving a location, requiring multiple fine adjustments, when the aiming direction is adjusted by adjusting the viewing angle or moving the location in the related art; and second, this avoids incorrect aiming of the throwable catching item at another virtual object on which the virtual item effect fails.

Next, a method for operating a virtual throwable item in a virtual environment is described by using the following embodiments.

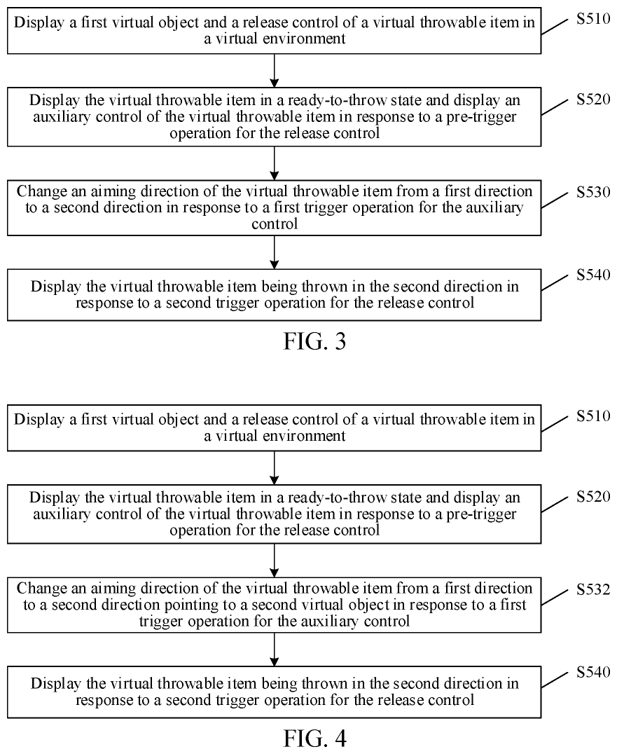

FIG. 3 is a flowchart of a method for operating a virtual throwable item in a virtual environment according to an exemplary embodiment of this application. The method may be performed by a terminal. The method includes:

Operation 510: Display a first virtual object and a release control of a virtual throwable item in a virtual environment.

The first virtual object carries the virtual throwable item, and the virtual throwable item may be picked up by the first virtual object in the virtual environment, or may be acquired by the first virtual object before entering the virtual environment. In this application, the terminal performing the method for operating the virtual throwable item in the virtual environment is a control terminal of the first virtual object.

For example, when an application program providing the virtual environment is a first-person game, since the virtual environment is observed from a first-person viewing angle of the first virtual object, the displayed first virtual object usually includes only a hand and an arm of the first virtual object. When an application program providing the virtual environment is a third-person game, the virtual environment and the first virtual object are observed by a third person, and the displayed first virtual object usually includes an upper body or even the whole body of the first virtual object. A display mode of the first virtual object is not limited in this application.

For example, the release control of the virtual throwable item provides a functional entry for using the virtual throwable item in the virtual environment. The release control may be non-transparent or semi-transparent on the terminal, and the virtual throwable item is used by triggering the release control.
Operation 520: Display the virtual throwable item in a ready-to-throw state and display an auxiliary control of the virtual throwable item in response to a pre-trigger operation for the release control.

For example, the pre-trigger operation for the release control is usually implemented with the mode of maintaining holding and pressing the release control, but other human-computer interaction modes are further included. For example, an operation of clicking/tapping the release control for the first time is a pre-trigger operation, and an operation of clicking/tapping the release control for more than a preset duration (such as two seconds) is a pre-trigger operation.

The pre-trigger operation is configured for indicating a willingness to use the virtual throwable item by an end user. In response to the pre-trigger operation, the displayed ready-to-throw state is a stage in which the first virtual object holds the virtual throwable item and prepares to throw the virtual throwable item. For example, the virtual throwable item being in a ready-to-throw state is indicated by at least one of the following: changing a posture of the first virtual object hand-holding the virtual throwable item, displaying more auxiliary throwing lines of the virtual throwable item, and displaying more prompt information indicating that the virtual throwable item is in the ready-to-throw state.

For example, in the ready-to-throw state, the aiming direction of the virtual throwable item is a first direction. The first direction is a direction faced by the first virtual object when the terminal receives the pre-trigger operation, or a direction faced by a camera model when observing the virtual environment through the camera model.

For example, the first direction is a direction from a location of the first virtual object in the virtual environment to a location of interest, and the location of interest is located at a preset location (such as a center point) in an observation picture of the virtual environment displayed by the terminal.

For example, the auxiliary control is displayed in response to the pre-trigger operation. Displaying the auxiliary control may be configured for indicating no display of the auxiliary control before the terminal receives the pre-trigger operation. However, a case that an auxiliary control exists before the terminal receives the pre-trigger operation, but the auxiliary control is in an unavailable state is not excluded.
Operation 530: Change the aiming direction of the virtual throwable item from the first direction to a second direction in response to a first trigger operation for the auxiliary control.

For example, the first trigger operation for the auxiliary control is usually a click/tap operation, but another human-computer interaction mode is further included, such as long press, and double-click/double-tap. The auxiliary control provides a functional entry for quickly adjusting the aiming direction of the virtual throwable item. A form of the auxiliary control is not limited in this embodiment of this application. For example, the auxiliary control may be a gazing control (such as a gazing control of an eye pattern). After the functional entry is triggered, the adjusted aiming direction is the second direction. The second direction is a direction from the first virtual object to a second virtual object in the virtual environment, and the second virtual object is an effective action object of the virtual throwable item.

The virtual throwable item has a capability of generating an item effect on the effective action object, and the generated item effect varies based on diverse types of the virtual throwable item. For example, if the virtual throwable item is a virtual attack item (such as a virtual grenade), the generated item effect is to reduce virtual health points. Correspondingly, if a virtual object is an effective action object (for example, the foregoing virtual object and the first virtual object have an adversarial relationship), the virtual health points are reduced when the foregoing virtual object is in an effect range of a virtual attack item. If a virtual object is not an effective action object (for example the foregoing virtual object and the first virtual object have a teammate relationship), even if the foregoing virtual object is located within the effect range of the virtual attack item, no decrease in health points may be caused.
Operation 540: Display the virtual throwable item being thrown in the second direction in response to a second trigger operation for the release control. In other words, the first virtual object is caused to throw the virtual throwable item in the second direction in response to the second trigger operation on the release control.

For example, when the pre-trigger operation for the release control is implemented as maintaining holding and pressing the release control, the second trigger operation is usually implemented as relieving the press-and-hold operation for the release control (or referred to as no longer pressing and holding the release control). However, other human-computer interaction modes are not excluded.

For example, after the virtual throwable item is thrown toward the second direction, a landing location of the virtual throwable item in the virtual environment or an effect location of the virtual throwable item in the virtual environment is a location of the second virtual object.

In conclusion, in the method provided in this embodiment, the first virtual object and the release control of the virtual throwable item in the virtual environment are displayed, and the first virtual object carries the virtual throwable item. When the virtual throwable item needs to be used, the pre-trigger operation may be performed on the release control in response to the pre-trigger operation for the release control, to display that the virtual throwable item is in the ready-to-throw state. The auxiliary control is displayed when the virtual throwable item is in the ready-to-throw state, to provide a functional entry for quickly adjusting the aiming direction of the virtual throwable item. Next, if the aiming direction of the virtual throwable item needs to be adjusted to aim at the second virtual object, the first trigger operation may be performed only on the auxiliary control, so that the aiming direction of the virtual throwable item is quickly adjusted to the second direction pointing to the second virtual object in response to the first trigger operation for the auxiliary control, without requiring another operation, and throwing the virtual throwable item in the second direction is displayed in response to the second trigger operation for the release control, to enable the virtual throwable item to act on the second virtual object. In this application, the auxiliary control provides the functional entry for quickly adjusting the aiming direction of the virtual throwable item. First, this avoids a problem of low human-computer interaction efficiency caused by an inaccurate operation of a novice player for adjusting a viewing angle or moving a location, requiring multiple fine adjustments, when the aiming direction is adjusted by adjusting the viewing angle or moving the location in the related art; and second, this avoids incorrect aiming of the virtual throwable item at another virtual object on which the virtual item effect fails.

Next, a second virtual object determination mode is described.

FIG. 4 is a flowchart of a method for operating a virtual throwable item in a virtual environment according to an exemplary embodiment of this application. The method may be performed by a terminal. In an embodiment shown in FIG. 3, operation 530 may be implemented as operation 532.
Operation 532: Change the aiming direction of the virtual throwable item from the first direction to a second direction pointing to a second virtual object in response to a first trigger operation for the auxiliary control.

In this embodiment, the virtual environment includes at least two candidate virtual objects, and each candidate virtual object of the at least two candidate virtual objects is an effective action object of the virtual throwable item; and the second virtual object is a virtual object selected from the at least two candidate virtual objects, and the second virtual object is determined in response to the first trigger operation, and is a preferably aimed virtual object.

For example, the second virtual object is selected from the at least two candidate virtual objects, and is a virtual object having a minimum distance relative to the first virtual object. As described above, the first direction is an initial direction of the virtual throwable item in the ready-to-throw state.

When the aiming direction of the virtual throwable item is adjusted to the second direction in response to the first trigger operation, correction is performed with reference to the aiming direction of the virtual throwable item in the ready-to-throw state, to quickly aim at the candidate virtual object with the distance offset value relative to the first virtual object, so that the aiming direction is adjusted quickly to aim at the virtual object on which the virtual throwable item can generate the item effect; and furthermore, when the first virtual object is in the ready-to-throw state, the first virtual object has a willingness to throw the virtual throwable item in an original direction (such as the first direction), to ensure that the virtual throwable item generates the item effect, the auxiliary control provides the functional entry for quickly adjusting the aiming direction, rapid adjustment is performed in the roughly-aligned original direction, the second direction can be accurately aimed, thereby ensuring that the thrown virtual throwable item generates the item effect on the second virtual object.

Next, the distance relative to the first virtual object is described. In an exemplary implementation, operation 532 in this embodiment may be implemented as the following three sub-operations:
Establish a first ray in the virtual environment in response to the first trigger operation for the auxiliary control.

For example, the first ray established in the virtual environment is a ray starting from the first virtual object and propagating along the first direction. The first ray is not limited to being visible on the terminal in this embodiment.
Calculate a distance between each candidate virtual object of the at least two candidate virtual objects and the first ray, to obtain distances corresponding to the at least two candidate virtual objects, respectively.

A distance between the candidate virtual object and the first ray is a minimum distance between the candidate virtual object and the first ray, i.e., the distance. In this embodiment, the distance is the candidate virtual object relative to the first direction.
Determine a second virtual object based on the distances respectively corresponding to the at least two candidate virtual objects, and changing the aiming direction of the virtual throwable item from the first direction to the second direction.

As described above, the at least two distances correspond one-to-one with the at least two candidate virtual objects, and the distance corresponding to the determined second virtual object is a minimum value of the distances respectively corresponding to the at least two candidate virtual objects.

The second virtual object is a candidate virtual object with the minimum distance relative to the first virtual object, and when the first virtual object is in the ready-to-throw state, the first virtual object has the willingness to throw the virtual throwable item in the first direction, and since the viewing angle and location of the virtual object may be incorrectly adjusted in a ready-to-throw stage, the first direction may not aim at the virtual object in the virtual environment. The aiming direction is adjusted to the second direction in response to the first trigger operation, so that the second virtual object is quickly aimed; and the second virtual object is the virtual object having the minimum distance relative to the first virtual object, and is the virtual object to which the virtual throwable item is most inclined to throw in the ready-to-throw stage. In addition, the aiming direction is adjusted to the location of the candidate virtual object having the minimum distance relative to the first virtual object, thereby avoiding a large-angle viewing angle rotation of the observation picture of the virtual environment displayed on the terminal, and preventing disruption to a sense of immersion in the virtual environment.

In another exemplary implementation, when there are a plurality of virtual objects with the minimum distances relative to the first direction, the second virtual object is a virtual object, closest to the first virtual object, among the plurality of virtual objects. Using the observation of the virtual environment through a camera model as an example, the virtual object closest to the first virtual object is determined as the second virtual object. This considers an imaging rule of the camera model that objects closer appear larger when observing the virtual environment. The virtual object closest to the first virtual object has a larger display size on the terminal and has visual prominence, so that a controller of the terminal is most willing to throw the virtual throwable item to the virtual object.

And/or when there are a plurality of virtual objects with minimum distances relative to the first direction, the second virtual object is a virtual object displayed on different sides from the first virtual object on the terminal. An example in which an application program providing the virtual environment is a third-person game is used. In the third-person game, an upper-body picture or even a full-body picture of the first virtual object is displayed, and the first virtual object is displayed on a side of the terminal. For example, an area of the first virtual object on a first side of a longitudinal central axis of the terminal is larger than an area on a second side, and the first virtual object is displayed on the first side of the terminal. Since the display of the first virtual object on the terminal obscures a substantial portion of one side of the picture, resulting in more observation information of the candidate virtual objects in the virtual environment from the other side of the terminal display, the second virtual object is the virtual object displayed on a different side of the terminal from the first virtual object. Considering the obstruction of the first virtual object for the observation picture of the virtual environment, the second virtual object is determined as the virtual object that is located on the different side from the first virtual object and to which the controller of the terminal is most willing to throw the virtual throwable item.

In conclusion, in the method provided in this embodiment, the auxiliary control is displayed when the virtual throwable item is in the ready-to-throw state, which provides the functional entry for quickly adjusting the aiming direction of the virtual throwable item. The aiming direction of the virtual throwable item is quickly adjusted to the second direction pointing to the second virtual object in response to the first trigger operation for the auxiliary control. The second direction points to the location of the second virtual object, and the second virtual object is selected from a plurality of candidate virtual objects and is the virtual object to which the virtual throwable item is most inclined to throw. This avoids a problem of low human-computer interaction efficiency caused by an inaccurate operation of a novice player for adjusting a viewing angle or moving a location, requiring multiple fine adjustments, when the aiming direction is adjusted by adjusting the viewing angle or moving the location in the related art, and the aiming direction can be quickly aligned with the location of the second virtual object.

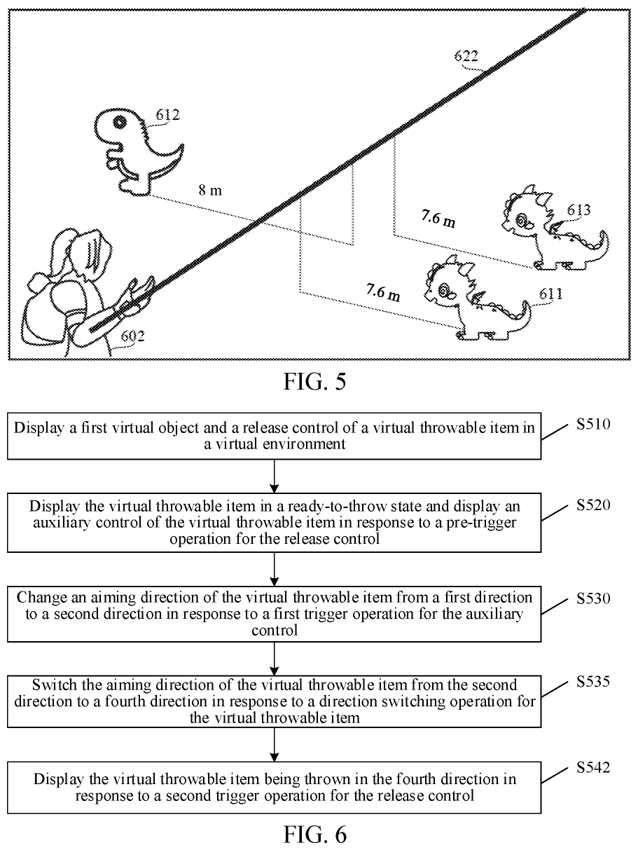

FIG. 5 is a schematic diagram of a candidate virtual object according to an exemplary embodiment of this application. In FIG. 5, a first virtual object 602 and three candidate virtual objects (including a first candidate object 611, a second candidate object 612, and a third candidate object 613) are used as an example for description.

A first ray 622 is a ray starting from the first virtual object 602, and pointing to the aiming direction of a virtual throwable item held by the first virtual object 602.

Distances between the first candidate object 611 to the third candidate object 613 and the first ray 622 are calculated one by one, to obtain three distances corresponding one-to-one with the foregoing three candidate virtual objects. For example, the distance between the candidate virtual object and the first ray 622 is a minimum linear distance. For example, a distance between the first candidate object 611 and the first ray 622 is 7.6 m, a distance between the second candidate object 612 and the first ray 622 is 8 m, and a distance between the third candidate object 613 and the first ray 622 is 7.6 m.

The distances from the first candidate object 611 and the third candidate object 613 to the first ray 622 are both the minimum value, i.e., 7.6 m, among the three candidate virtual objects. The first candidate object 611 is the virtual object, closest to the first virtual object, of the first candidate object 611 and the third candidate object 613. The aiming direction of the virtual throwable item is changed to a direction of the first candidate object 611 in response to the first trigger operation for the auxiliary control. To be specific, the aiming direction of the virtual throwable item is locked to the first candidate object 611 in response to the first trigger operation for the auxiliary control.

FIG. 6 is a flowchart of a method for operating a virtual throwable item in a virtual environment according to an exemplary embodiment of this application. The method may be performed by a terminal. To be specific, based on the embodiment shown in FIG. 3, operation 535 is further included, and operation 540 may be implemented as operation 542.
Operation 535: Switch the aiming direction of the virtual throwable item from the second direction to a fourth direction in response to a direction switching operation for the virtual throwable item.

For example, the direction switching operation for the virtual throwable item is received after the first trigger operation for the auxiliary control. The direction switching operation is configured for adjusting the aiming direction of the virtual throwable item from the location of one virtual object to a location of another virtual object.

For example, after the adjustment, the fourth direction aimed by the virtual throwable item is a direction from the first virtual object to the third virtual object in the virtual environment. The third virtual object and the second virtual object are different virtual objects. The third virtual object and the second virtual object are similar, and are both effective action objects of the virtual throwable item, and the virtual throwable item can produce an item effect for the third virtual object.

For example, the direction switching operation is usually a sliding operation, but another human-computer interaction mode is not excluded, such as click/tap, long press, or double-click/double-tap. In one example, when the aiming direction is switched in response to the direction switching operation, the aiming direction is switched from the second direction to a third direction, and there may be a transition phase during the switching of the aiming direction, such as a transition animation or a transition frame.

In one example, the direction switching operation is a sliding operation, and the sliding operation is an operation that a sliding distance exceeds a preset distance (the preset distance may be either a physical distance, such as 2 cm, or a pixel distance, such as 10 pixels (PX)). In this embodiment, if the sliding distance exceeds the preset distance, the aiming direction of the virtual throwable item is switched to the third direction. In one example, the preset distance is 10 PX. Even if the sliding distance is longer than the preset distance, such as the sliding distance is 13 PX, 15 PX, etc., the aiming direction may only be adjusted to the third direction. No further adjustments may be performed on the aiming direction, nor is the aiming direction adjusted to a direction with no virtual object.

The foregoing direction switching operation is different from a viewing angle rotating operation. In a viewing angle sliding operation, a rotating angle of the viewing angle is in positive correlation with the sliding operation, and they correspond one-to-one. For example, each time a sliding length of the sliding operation is increased by 1 pixel, the rotating angle of the viewing angle is increased by 1°.

FIG. 7 is a schematic diagram of a virtual environment according to an exemplary embodiment of this application. A fourth interface 340 is displayed in response to the direction switching operation for the virtual throwable item after the aiming direction of the virtual throwable item is displayed as the second direction.

Referring to FIG. 2 above, an example in which the virtual throwable item is a throwable catching item is used for description. For example, the direction switching operation for the virtual throwable item is a rightward-sliding operation 426. The aiming direction of the throwable catching item is switched from the second direction aiming at a pet virtual object 404 to a fourth direction aiming at another pet virtual object 406 in response to the rightward-sliding operation 426. Since the direction switching operation is the rightward-sliding operation 426, the another pet virtual object 406 is located on the right side of the pet virtual object 404.
Operation 542: Display the virtual throwable item being thrown in the fourth direction in response to a second trigger operation for the release control.

For example, after the virtual throwable item is thrown toward the fourth direction, a landing location of the virtual throwable item in the virtual environment or an effect location of the virtual throwable item in the virtual environment is the location of the third virtual object.

In conclusion, in the method provided in this embodiment, after the auxiliary control is triggered, the functional entry for switching an aimed virtual object is provided through the direction switching operation. After the auxiliary control is triggered, the aiming direction of the virtual throwable item is switched from the direction pointing to the second virtual object to the direction pointing to the third virtual object in response to the direction switching operation, so that the pointed virtual object can be quickly switched. This avoids the problem in the related art that finding another virtual object by rotating the viewing angle requires frequent adjustment for the observation viewing angle of the virtual environment, resulting in cumbersome adjustment of the aiming direction, thereby improving human-computer interaction efficiency.

Next, the third virtual object in the embodiment shown in FIG. 6 is further described.

As described above, the third virtual object includes at least one of the following:
A virtual object associated with a virtual task accepted or selected by the first virtual object.

The accepted or selected virtual task indicates a purpose of a virtual activity preferentially executed by the first virtual object in the virtual environment, and the first virtual object needs to interact (such as dialog or combat) with the virtual object associated with the virtual task, to complete the virtual task. In this embodiment, the first virtual object needs to throw the virtual throwable item to the virtual object associated with the virtual task, and completes the virtual task by means of at least one of the following modes: causing virtual injury to the virtual object, providing virtual support, and catching the virtual object.

The third direction is determined to point to the location of the virtual object associated with the virtual task, thereby improving the virtual task execution efficiency of the first virtual object, and avoiding missing the virtual object associated with the virtual task due to the presence of a plurality of virtual objects in the virtual environment.
A virtual object having a historical record of defeating the first virtual object.

The virtual object that has defeated the first virtual object poses a historical security risk to the first virtual object. The third virtual object is determined as the virtual object with the historical record of defeating the first virtual object, prompting the first virtual object to be aware of the third virtual object. When the virtual throwable item is a virtual attack item, priority is given to launching a virtual attack against the virtual object with the historical record of defeating the first virtual object, thereby effectively highlighting the virtual object in the environment that poses the security risk to the first virtual object.
A virtual object launching a virtual attack against the first virtual object.

The virtual object launching the virtual attack against the first virtual object poses an immediate security risk to the first virtual object. The third virtual object is determined as the virtual object launching the virtual attack, prompting the first virtual object to be aware of the third virtual object. When the virtual throwable item is a virtual attack item, priority is given to counterattacking the virtual object launching the virtual attack, interrupting the virtual attack launched by the virtual object, thereby avoiding sustained virtual attacks from the virtual object, and effectively highlighting the virtual object in the environment that poses the security risk to the first virtual object.
A virtual object whose moving direction is away from a throwing range of the virtual throwable item.

The foregoing virtual object is far away from the throwing range of the virtual throwable item. At a next moment or a longer future moment, movement of the virtual object may go beyond the throwing range of the virtual throwable item, and the virtual throwable item is incapable of producing an item effect on the virtual object. Priority is given to enabling the aiming direction of the virtual throwable item to point to the virtual object, which can effectively highlight the virtual object, on which the virtual throwable item is incapable of producing the item effect due to the limitation of the throwing range, in the virtual environment if the virtual throwable item is thrown with a delay.

In conclusion, in the method provided in this embodiment, the aiming direction of the virtual throwable item is adjusted to point to the third virtual object, and the third virtual object is determined from the candidate virtual objects based on behaviors of the virtual objects at a current moment or historical moments in the virtual environment. This determination fully considers a priority purpose of the first virtual object in executing virtual activities, and the security risks posed to the first virtual object by other virtual objects in the virtual environment. The third virtual object is determined with respect to the virtual environment in which the first virtual object is located, and the virtual object to which the aiming direction of the virtual throwable item points is determined based on a condition in the virtual environment.

Next, a release control of a virtual throwable item is described.

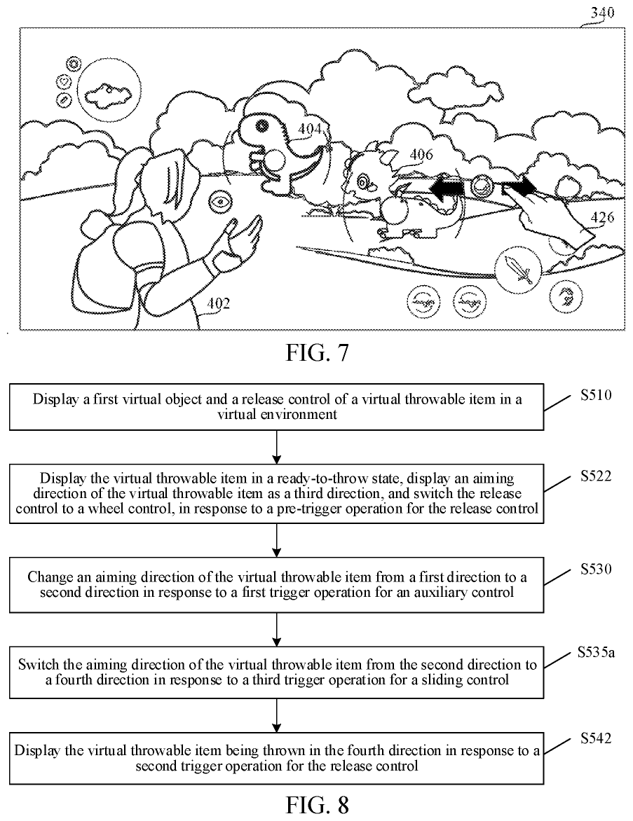

FIG. 8 is a flowchart of a method for operating a virtual throwable item in a virtual environment according to an exemplary embodiment of this application. The method may be performed by a terminal. To be specific, based on the embodiment shown in FIG. 6, operation 520 may be implemented as operation 522. Operation 535 may be implemented as operation 535a.
Operation 522: Display the virtual throwable item in a ready-to-throw state, display the aiming direction of the virtual throwable item as a third direction, and switch the release control to a wheel control, in response to the pre-trigger operation for the release control.

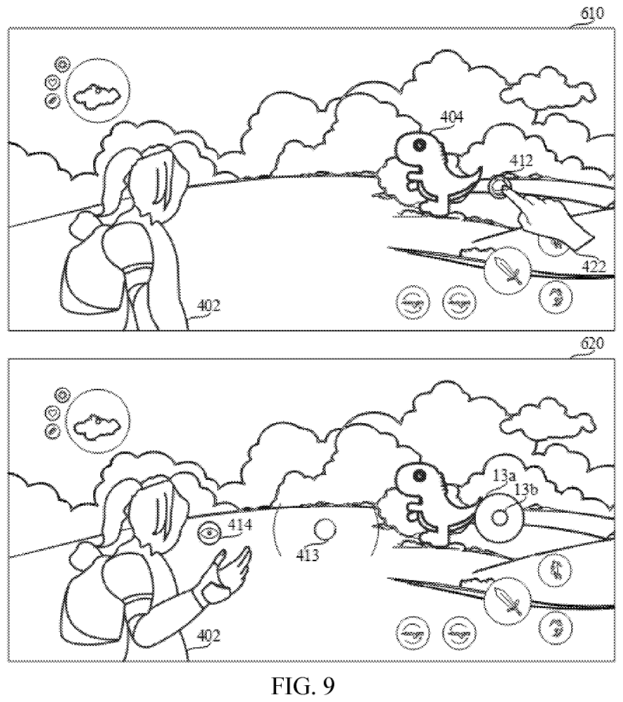

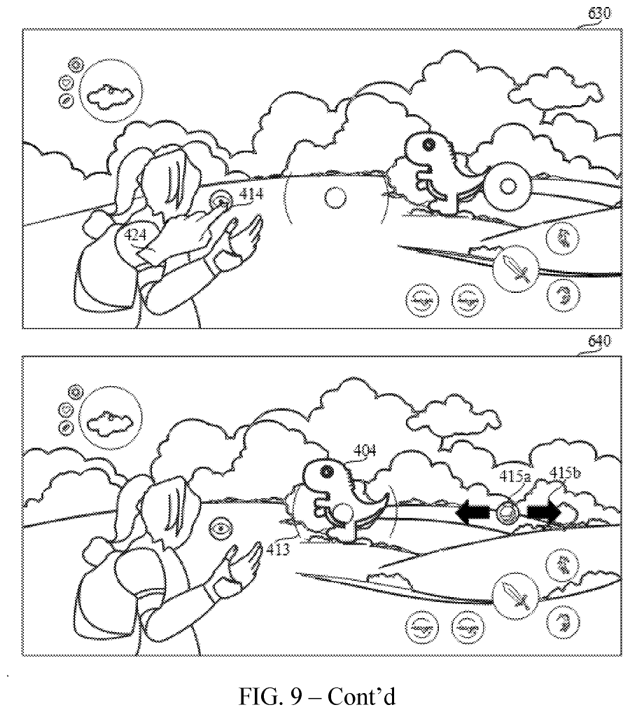

For example, the wheel control is configured to provide a functional entry for changing the aiming direction of the virtual throwable item. In one example, the wheel control includes a wheel area and a rocker portion. For example, referring to a second moment interface 620 in FIG. 9, a wheel area 13a and a rocker portion 13b are both circular, and a display area of the rocker portion 13b is smaller than a display area of the wheel area 13a. The aiming direction of the virtual throwable item is adjusted by performing a drag-and-drop operation on the rocker portion. For example, the aiming direction of the virtual throwable item points to a preset location in an observation picture of the virtual environment. The drag-and-drop operation performed on the rocker portion is performed to adjust the aiming direction of the virtual throwable item by changing a viewing angle for observing the virtual environment. The drag-and-drop operation on the rocker portion may further adjust a pointed location of the aiming direction points in the observation picture (for example, the aiming direction moves from a center point of the observation picture to another location in a direction of the drag-and-drop operation) when the viewing angle for observing the virtual environment remains unchanged.

In an exemplary implementation, this embodiment further includes at least one of the following two sub-operations:
Change the aiming direction of the virtual throwable item from the third direction to the first direction at a first observation viewing angle of the first virtual object when the drag-and-drop operation for the wheel control does not go beyond the wheel control.

In this embodiment, the wheel control is displayed in the first area in a superposing mode, and the first area is configured to provide a functional entry for changing the observation viewing angle of the first virtual object. The first area is further referred to as a first hot spot. The viewing angle for observing the virtual environment is adjusted in response to a sliding operation in the first area. Referring to the foregoing descriptions about the rotating operation of the viewing angle, the sliding operation in the first area is in positive correlation with the rotating angle of the viewing angle, and they correspond one-to-one.

In this operation, for a case that the drag-and-drop operation of the wheel control does not go beyond the wheel control, the drag-and-drop operation only has an intention of adjusting the aiming direction of the virtual throwable item, a distance of the drag-and-drop operation is relatively small, the aiming direction is finely adjusted, and the drag-and-drop operation is performed by the player when an offset between the third direction and the first direction is relatively small.

The first observation viewing angle of the first virtual object is a current observation viewing angle, the first observation viewing angle is kept unchanged, and the aiming direction of the virtual throwable item is changed from the third direction to the first direction in a manner of changing a location of the aiming direction in the observation picture. A change direction of the first direction relative to the third direction is the same as a direction of the drag-and-drop operation. For example, the drag-and-drop operation is to drag the rocker portion of the wheel control rightwards. A first location of the first direction in the observation picture is located on the right side of a third location in the observation picture. For example, not exceeding the wheel control indicates that the drag-and-drop operation does not go beyond the wheel area of the wheel control, and is a drag-and-drop operation in a short distance.
Change the observation viewing angle of the first virtual object from the first observation viewing angle to a second observation viewing angle when the drag-and-drop operation for the wheel control goes beyond the wheel control.

In this operation, when the drag-and-drop operation for the wheel control goes beyond the wheel control, the drag-and-drop operation indicates an intention to adjust the observation viewing angle of the virtual environment, and the drag-and-drop distance is large, representing a large-angle adjustment of the aiming direction. The player performs this operation when an offset between the third direction and the first direction is large. The adjusted aiming direction goes beyond the current observation picture or is at an edge location of the current observation picture. The adjusted aiming direction needs to be displayed (for example, displayed in a center area of the observation picture) in a mode of visual significance by adjusting the viewing angle.

In one example, the third direction is located at the center point in the observation picture of the first observation viewing angle, and the first direction is located at the center point in the observation picture of the second observation viewing angle. Since the observation viewing angle is rotated, the aiming direction of the virtual throwable item is rotated as well. The direction in which the first observation viewing angle is rotated to the second observation viewing angle is the same as the direction of the drag-and-drop operation. For example, the drag-and-drop operation is to drag the rocker portion of the wheel control rightwards, and correspondingly, the camera model observing the virtual environment is rotated rightwards from the first observation viewing angle to the second observation viewing angle.

Technical solutions are provided for meeting different aiming direction adjustment requirements based on whether the drag-and-drop operation goes beyond the wheel control. When the aiming direction is only required to be adjusted in a small angle, the viewing angle for observing the virtual environment remains unchanged, and the disruption to the sense of immersion for the virtual environment is avoided; and when the aiming direction is required to be adjusted in a large angle, the viewing angle for observing virtual environment is rotated, to change the aiming direction, and observe a peripheral environment of the aiming direction.
Operation 522 in this embodiment may be combined with operation 510, operation 530, and operation 540 in FIG. 3 into a new single embodiment. This is not limited in this embodiment.
Operation 535a: Switch the aiming direction of the virtual throwable item from the second direction to a fourth direction in response to a third trigger operation for a sliding control.

For example, the sliding control is obtained by updating the release control in response to the first trigger operation for the auxiliary control. In this embodiment, operation 522 and operation 535a are sequentially performed, and the wheel control in operation 522 is switched to the sliding control in response to the first trigger operation for the auxiliary control. For example, the sliding control is a control triggered by a sliding operation. Correspondingly, the third trigger operation is a sliding operation for the sliding control. Certainly, operation 535a may further be independently performed, without depending on 522.

In one example, prompt information is further displayed around the sliding control, and the prompt information is configured for indicating a sliding mode (such as a sliding direction of the sliding operation) of the third trigger operation. For example, referring to a fourth moment interface 640 in FIG. 9, prompt information 415b around a sliding control 415a is configured for indicating that a sliding direction of the third trigger operation for the sliding control is sliding leftward or sliding rightward.

When the pre-trigger operation for the release control is to keep holding and pressing the release control, and in operation 522, the release control is changed to the wheel control in response to the pre-trigger operation, so that the aiming direction of the virtual throwable item can be adjusted by dragging the rocker portion of the wheel control when the press-and-hold operation implementing the pre-trigger operation is kept. In operation 535a, the sliding control is displayed after the auxiliary control is triggered, so that the press-and-hold operation implementing the pre-trigger operation can be continuously kept after the auxiliary control is triggered, to switch the aiming direction among different virtual objects. It can be seen from the above that in operation 522 and operation 535a the release control is switched to a control in other forms, so that the virtual throwable item can remain in the ready-to-throw state based on the fact that the pre-trigger operation is implemented as keeping pressing and holding the release control, and the aiming direction of the virtual throwable item can be adjusted when in the ready-to-throw state.

FIG. 9 is a schematic diagram of a virtual environment according to an exemplary embodiment of this application.

A first moment interface 610 is an interface displayed on the terminal at a first moment, and like FIG. 2, descriptions are provided by using an example in which the virtual throwable item is a throwable catching item.

A first virtual object 402 and a release control 412 of a throwable catching item are displayed in the first moment interface 610. The virtual environment further includes a pet virtual object 404, and the throwable catching item acts on the pet virtual object 404 (i.e., the second virtual object) to generate an item effect of catching.

A second moment interface 620 is displayed at a second moment in response to a press-and-hold operation 422 (i.e., the pre-trigger operation) for the release control 412 of the throwable catching item received by the terminal at the first moment.

In the second moment interface 620, the first virtual object 402 raises an arm, and prepares to throw the throwable catching item. This is in a ready-to-throw state. An aiming reticle 413 is displayed, and the aiming reticle 413 indicates an aiming direction of the throwable catching item.

An auxiliary control 414 is displayed in the second moment interface 620. Before the second moment, the auxiliary control 414 is not displayed, and the auxiliary control is displayed in response to the press-and-hold operation 422 for the release control 412 of the throwable catching item.

The release control 412 of the throwable catching item in the second moment interface 620 is switched to the wheel control. As described above, the wheel control includes a wheel area 13a and a rocker portion 13b that are both circular, and a display area of the rocker portion 13b is smaller than a display area of the wheel area 13a. The rocker portion 13b can be dragged to move in a circular range shown in the wheel area 13a.

In a third moment interface 630, the terminal receives a click/tap operation 424 (i.e., the first trigger operation) for the auxiliary control 414, and the fourth moment interface 640 is displayed at a fourth moment in response to the click/tap operation.

In the fourth moment interface 640, the aiming direction of the throwable catching item is changed to a second direction, and the second direction points to a location of the pet virtual object 404, namely, the aiming reticle 413 aims at the pet virtual object 404.

In the fourth moment interface 640, the wheel control displayed at the third moment is changed to a sliding control 415a, and prompt information 415b around the sliding control 415a is configured for indicating that a sliding direction of the third trigger operation for the sliding control is sliding leftward or sliding rightward. For the third trigger operation of the sliding control, refer to the direction switching operations in FIG. 6 and FIG. 7. Details are not repeated herein.
Operation 535a in this embodiment may be combined with operation 510, operation 520, and operation 540 in FIG. 3 into a new single embodiment. This is not limited in this embodiment.

In conclusion, in the method provided in this embodiment, the release control is switched to the wheel control in response to the pre-trigger operation, so that the aiming direction of the virtual throwable item can be adjusted by dragging the rocker portion of the wheel control when the press-and-hold operation implementing the pre-trigger operation is kept. It is ensured that after the auxiliary control is triggered, the press-and-hold operation implementing the pre-trigger operation can be continuously maintained, and the aiming direction is switched among different virtual objects. The continuous press-and-hold operation is maintained when the virtual object is in the ready-to-throw state, and the aiming direction of the virtual throwable item is adjusted by sliding during the press-and-hold operation, to avoid designing an interaction that needs frequent touch operations, reduce human-computer interactions, and improve human-computer interaction efficiency.

In an exemplary implementation, operation 535a may be implemented as at least one of the following two sub-operations:
Switch the aiming direction of the virtual throwable item from the second direction to a fourth direction pointing to a third virtual object on a first side of the second virtual object in response to a first sliding operation for the sliding control; and
Switch the aiming direction of the virtual throwable item from the second direction to the fourth direction pointing to the third virtual object on a second side of the second virtual object in response to a second sliding operation for the sliding control, where sliding directions of the first sliding operation and the second sliding operation are opposite.

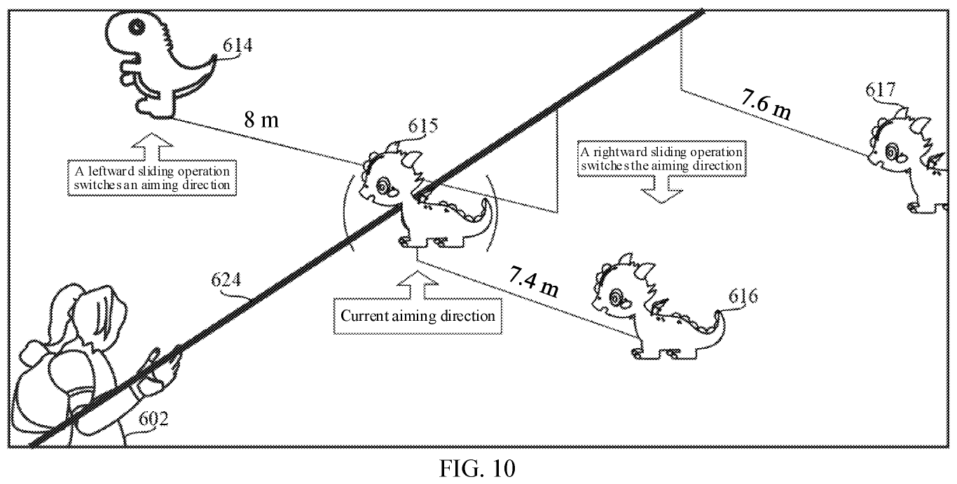

FIG. 10 is a schematic diagram of a candidate virtual object according to an exemplary embodiment of this application. In an example shown in FIG. 10, a first virtual object 602 and four candidate virtual objects (including a fourth candidate object 614, a fifth candidate object 615, a sixth candidate object 616, and a seventh candidate object 617) are used as an example for description.

A second ray 624 is a ray starting from the first virtual object 602 and pointing to the fifth candidate object 615. The second ray 624 corresponds to the second direction that is changed in response to the first trigger operation for the auxiliary control. Referring to descriptions of operation 530 above, the fifth candidate object 615 is further referred to as the second virtual object.

Distances between the three candidate virtual objects (excluding the fifth candidate object 615) of the four candidate virtual objects and the second ray 624 are calculated to obtain three distances corresponding one-to-one with the above three candidate virtual objects.

Using an example in which the first sliding operation is sliding leftward, the aiming direction of the virtual throwable item is switched a direction pointing to the fourth candidate object 614 on a left side of the fifth candidate object 615.

Using an example in which the first sliding operation is sliding rightward, the aiming direction of the virtual throwable item is switched to a direction pointing to one candidate object on the right side of the fifth candidate object 615. A distance between the sixth candidate object 616 and the second ray 624 is less than a distance between the seventh candidate object 617 and the second ray 624, the aiming direction of the virtual throwable item is switched to a direction pointing to the sixth candidate object 616 on the right side of the fifth candidate object 615.

In one example, the virtual throwable item is a throwable attack item. Details are as follows:
Display a first virtual object and a release control of the throwable attack item.

The first virtual object carries the throwable attack item, such as a virtual grenade, and a virtual Molotov cocktail, and the release control of the throwable attack item provides a functional entry for using the throwable attack item in the virtual environment.
Display the throwable attack item in a ready-to-throw state and display an auxiliary control of the throwable attack item in response to the pre-trigger operation for the release control.

When the throwable attack item is in the ready-to-throw state, an aiming direction of the throwable attack item is a first direction; and the first direction is a direction pointing to the first virtual object when the terminal receives the pre-trigger operation.
Change the aiming direction of the throwable attack item to a second direction pointing to the second virtual object having an adversarial relationship with the first virtual object in response to the first trigger operation for the auxiliary control.

The second direction is a direction from the first virtual object to the second virtual object in the virtual environment, and the second virtual object is an effective action object of the throwable attack item. Namely, the second virtual object and the first virtual object have the adversarial relationship.

In this embodiment, after the throwable attack item is thrown, virtual injury may be caused within an effect range, virtual health points of an enemy virtual object within the effect range are reduced, and virtual health points of an ally virtual object are not reduced. The second virtual object is an enemy virtual object on which the throwable attack item can generate an effect of reducing the health points. Further, the second virtual object is determined from at least two candidate virtual objects, and the at least two candidate virtual objects have an adversarial relationship with the first virtual object.

In some embodiments, the aiming direction of the throwable attack item is switched to a fourth direction in response to a direction switching operation for the throwable attack item.

The fourth direction is a direction from the first virtual object to the third virtual object in the virtual environment. The third virtual object is like the second virtual object, and the third virtual object and the first virtual object have an adversarial relationship.
Display the throwable attack item being thrown in the fourth direction in response to a second trigger operation for a location of the release control.

In another example, the virtual throwable item is a throwable support item. Details are as follows:
Display a first virtual object and a release control of a throwable support item.

The first virtual object carries the throwable support item, such as a virtual medical kit with regional effect; and the release control for the throwable support item provides a functional entry for using the throwable support item in the virtual environment.
Display the throwable support item in a ready-to-throw state and display an auxiliary control of the throwable support item in response to the pre-trigger operation for the release control.

When the throwable support item is in the ready-to-throw state, an aiming direction of the throwable support item is a first direction; and the first direction is a direction pointing to the first virtual object when the terminal receives the pre-trigger operation.
Change the aiming direction of the throwable support item to a second direction pointing to the second virtual object having a teammate relationship with the first virtual object in response to the first trigger operation for an auxiliary control.

The second direction is a direction from the first virtual object to the second virtual object in the virtual environment, and the second virtual object is an effective action object of the throwable support item. Namely, the second virtual object and the first virtual object have the teammate relationship.

In this embodiment, after being thrown, the throwable support item may increase the virtual health points of an ally virtual object within the effect range, but may not increase the virtual health points of the enemy virtual object. The second virtual object is an ally virtual object on which the throwable support item can generate an effect of increasing the health points. Further, the second virtual object is determined from at least two candidate virtual objects, and the at least two candidate virtual objects have a teammate relationship with the first virtual object.

In some embodiments, the aiming direction of the throwable support item is switched to a fourth direction in response to a direction switching operation for the throwable support item.

The fourth direction is a direction from the first virtual object to the third virtual object in the virtual environment. The third virtual object is like the second virtual object, and the third virtual object and the first virtual object have a teammate relationship.
Display the throwable support item being thrown in the fourth direction in response to a second trigger operation for a location of the release control.

In yet another example, the virtual throwable item is a throwable catching item. Details are as follows:
Display a first virtual object and a release control of a throwable catching item.

The first virtual object carries a throwable catching item, which has a capability of catching a pet virtual object in the virtual environment, such as a virtual catching ball; and the release control for the throwable catching item provides a functional entry for using the throwable catching item in the virtual environment.
Display the throwable catching item in a ready-to-throw state and display an auxiliary control of the throwable catching item in response to the pre-trigger operation for the release control.

When the throwable catching item is in the ready-to-throw state, an aiming direction of the throwable catching item is a first direction; and the first direction is a direction pointing to the first virtual object when the terminal receives the pre-trigger operation.
Change the aiming direction of the throwable catching item to a second direction pointing to the second virtual object that is a pet virtual object in response to the first trigger operation for the auxiliary control.

The second direction is a direction from the first virtual object to the second virtual object in the virtual environment, and the second virtual object is an effective action object of the throwable catching item. Namely, the second virtual object is a pet virtual object in the virtual environment.

In this embodiment, after the throwable catching item is thrown, an aimed pet virtual object may be caught without acting on another type of virtual object. The pet virtual object is usually a non-player character (NPC), but the possibility that the pet virtual object is a player character is further included. For example, catching a pet virtual object is configured for indicating that the ownership information of the pet virtual object is changed to the first virtual object; and further, the first virtual object has permission to instruct the owned pet virtual object to move based on the first virtual object.

In some embodiments, the aiming direction of the throwable catching item is switched to a fourth direction in response to a direction switching operation for the throwable catching item.

The fourth direction is a direction from the first virtual object to the third virtual object in the virtual environment. The third virtual object is like the second virtual object, and the third virtual object is a pet virtual object in the virtual environment.
Display the throwable catching item being thrown in the fourth direction in response to a second trigger operation for a location of the release control.

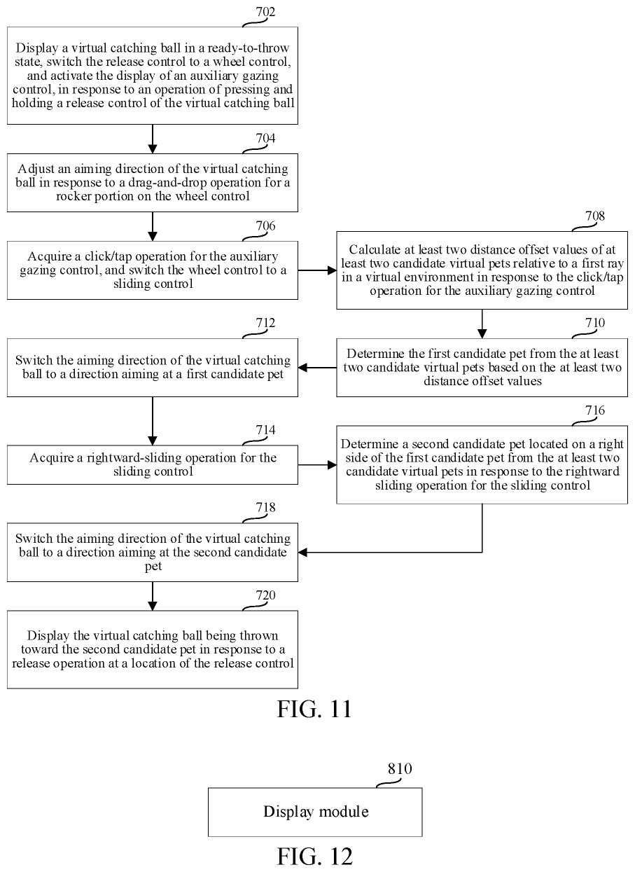

FIG. 11 is a flowchart of a method for operating a virtual throwable item in a virtual environment according to an exemplary embodiment of this application. The method includes:
Operation 702: Display a virtual catching ball in a ready-to-throw state, switch the release control to a wheel control, and activate the display of an auxiliary gazing control, in response to an operation of pressing and holding a release control of the virtual catching ball.

The virtual catching ball is a throwable catching item (i.e., a virtual throwable item). The virtual catching ball can catch the pet virtual objects (further known as virtual pets) in the virtual environment. For example, in response to the fact that the virtual catching ball comes into effect, the ownership information of the pet virtual object within an effect range of the virtual catching ball is changed to belonging to a thrower of the virtual catching ball.

For example, by displaying that the first virtual object holding the virtual catching ball raises an arm and prepares to throw the virtual catching ball, it is displayed that the virtual catching ball is in the ready-to-throw state.

For descriptions of the wheel control and the auxiliary control, refer to the foregoing various embodiments.
Operation 704: Adjust an aiming direction of the virtual catching ball in response to a drag-and-drop operation for a rocker portion on the wheel control.

For example, the aiming direction of the virtual catching ball points to a preset location in an observation picture of the virtual environment. The drag-and-drop operation is performed on the rocker portion to adjust the aiming direction of the virtual catching ball by changing a viewing angle of observing the virtual environment, so that the aiming direction is adjusted to the first direction. For matters that are not detailed in this embodiment, refer to operation 522 above.
Operation 706: Acquire a click/tap operation for an auxiliary gazing control, and switch the wheel control to a sliding control.

In response to the fact that the click/tap operation (i.e., the first trigger operation) for the auxiliary gazing control is acquired, a gazing mode provided by the auxiliary control is displayed. In the gazing mode, the aiming direction of the virtual catching ball automatically points to one virtual pet in the virtual environment.

For descriptions of the sliding control, refer to operation 535a mentioned above. Details are not repeated herein.
Operation 708: Calculate at least two distances of at least two candidate virtual pets relative to a first ray in the virtual environment in response to the click/tap operation for the auxiliary gazing control.

For example, the at least two candidate virtual pets correspond one-to-one with the at least two calculated distances. The first ray established in the virtual environment is a ray starting from the first virtual object and propagating along the first direction. This embodiment does not limit the first ray to being visible on the terminal. For descriptions of the first ray and the distances, refer to FIG. 4 above.
Operation 710: Determine the first candidate pet from the at least two candidate virtual pets based on the at least two distances.

The first candidate pet is one of the at least two candidate virtual pets in operation 708. Similarly, for a first candidate pet determination manner, refer to FIG. 4 above. The determined first candidate pet is the second virtual object.
Operation 712: Switch the aiming direction of the virtual catching ball to a direction aiming at the first candidate pet.

In some examples, the aiming direction of the displayed virtual catching ball is switched to the direction (i.e., the second direction) aiming at the first candidate pet in response to the click/tap operation for the auxiliary gazing control. Based on this, an observation picture of the virtual environment is a top-down viewing angle, a top view of the first virtual object and the first candidate pet is displayed to avoid mutual occlusion between the first virtual object and the first candidate pet, or mutual occlusion between the at least two candidate virtual pets in the virtual environment as described above.
Operation 714: Acquire a rightward-sliding operation for the sliding control.

As described above, the wheel control is switched to the sliding control. The rightward-sliding operation for the sliding control is configured for indicating the change of the aimed virtual pet. In this case, the rightward-sliding operation may be the direction switching operation for the virtual throwable item.
Operation 716: Determine a second candidate pet located on a right side of the first candidate pet from the at least two candidate virtual pets in response to a rightward-sliding operation for the sliding control.

The second candidate pet on the right side of the first candidate pet is determined based on the location of the candidate pet in the virtual environment. In this case, the second candidate pet may be a third virtual object.
Operation 718: Switch the aiming direction of the virtual catching ball to a direction aiming at the second candidate pet.

Like operation 712 above, after the aiming direction is switched to the direction aiming at the second candidate pet (i.e., a fourth direction), the observation picture of the virtual environment is maintained in the top-view viewing angle. Consequently, the mutual occlusion between the first virtual object and the first candidate pet, or the mutual occlusion between the at least candidate virtual pets in the virtual environment as described above is avoided.
Operation 720: Display the virtual catching ball being thrown toward the second candidate pet in response to a release operation at a location of the release control.

The release operation (i.e., the second trigger operation) at the location of the release control refers to no longer pressing and holding the release control. The virtual catching ball is triggered for use. The throwing direction of the virtual catching ball aims at the second candidate pet.

A first operation group includes operation 702, operation 704, operation 706, operation 712, operation 714, operation 718, and operation 720; and a second operation group includes operation 708, operation 710, and operation 716. In one example, operations in the first operation group are performed by the terminal, and operations in the second operation group are performed by the server. In another example, the terminal includes a display unit (such as a screen) and a processing unit (such as a central processing unit having a data processing capability or another processor). The operations in the first operation group are performed by the display unit of the terminal, and the operations in the second operation group are performed by the processing unit of the terminal.

An ordinary skilled person in the art may understand that the foregoing embodiments may be implemented independently, and may alternatively be combined freely into a new embodiment implementing the method for operating the virtual throwable item in the virtual environment of this application.

FIG. 12 is a structural block diagram of an apparatus for using a virtual throwable item according to an exemplary embodiment of this application. The apparatus includes:
a display module 810, configured to display a first virtual object and a release control of a virtual throwable item in a virtual environment, the first virtual object carrying the virtual throwable item, where
the display module 810 is further configured to display the virtual throwable item in a ready-to-throw state and display an auxiliary control of the virtual throwable item in response to a pre-trigger operation for the release control, and an aiming direction of the virtual throwable item in the ready-to-throw state is a first direction;
the display module 810 is further configured to change the aiming direction of the virtual throwable item from the first direction to a second direction in response to a first trigger operation for the auxiliary control, the second direction is a direction from the first virtual object to a second virtual object in the virtual environment, and the second virtual object is an effective action object of the virtual throwable item; and
the display module 810 is further configured to display the virtual throwable item being thrown in the second direction in response to a second trigger operation for the release control.

In an exemplary implementation of this embodiment, the virtual environment includes at least two candidate virtual objects, and each candidate virtual object of the at least two candidate virtual objects is the effective action object of the virtual throwable item.

The display module 810 is further configured to:
change the aiming direction of the virtual throwable item from the first direction to the second direction pointing to the second virtual object in response to the first trigger operation for the auxiliary control,
where the second virtual object is a virtual object having a minimum distance to the first virtual object among the at least two candidate virtual objects.

In an exemplary implementation of this embodiment, the display module 810 is further configured to
establish a first ray in the virtual environment in response to the first trigger operation for the auxiliary control, the first ray being a ray starting from the first virtual object and propagating along the first direction;
calculate a distance between each candidate virtual object of the at least two candidate virtual objects and the first ray, to obtain distances respectively corresponding to the at least two candidate virtual objects; and
determine the second virtual object based on the distances respectively corresponding to the at least two candidate virtual objects, and change the aiming direction of the virtual throwable item from the first direction to the second direction, the distance corresponding to the second virtual object being a minimum value of the distances respectively corresponding to the at least two candidate virtual objects.

In an exemplary implementation of this embodiment, when there are multiple virtual objects having the minimum distances relative to the first direction, the second virtual object is a virtual object closest to the first virtual object among the multiple virtual objects, and/or the second virtual object is a virtual object displayed on a different side from the first virtual object on the terminal.

In an exemplary implementation of this embodiment, the display module 810 is further configured to:
display the virtual throwable item in a ready-to-throw state, display an aiming direction of the virtual throwable item as the third direction, and switch the release control to a wheel control, in response to the pre-trigger operation for the release control, the wheel control being configured to provide a functional entry for changing the aiming direction of the virtual throwable item.

In an exemplary implementation of this embodiment, the wheel control is displayed in a first area in a superposing mode, and the first area is configured for providing a functional entry for changing an observation viewing angle of the first virtual object; and the apparatus is further configured to perform at least one of the following:
change the aiming direction of the virtual throwable item from the third direction to the first direction at a first observation viewing angle of the first virtual object when a drag-and-drop operation for the wheel control does not go beyond the wheel control, a changing direction of the first direction relative to the third direction being the same as a direction of the drag-and-drop operation; and
change the observation viewing angle of the first virtual object from the first observation viewing angle to a second observation viewing angle when the drag-and-drop operation for the wheel control goes beyond the wheel control, a direction in which the first observation viewing angle is rotated to the second observation viewing angle being the same as the direction of the drag-and-drop operation.

In an exemplary implementation of this embodiment, when the virtual throwable item is a throwable attack item, the second virtual object and the first virtual object have an adversarial relationship.

When the virtual throwable item is a throwable support item, the second virtual object and the first virtual object have a teammate relationship.

When the virtual throwable item is a throwable catching item, the second virtual object is a pet virtual object in the virtual environment.

In an exemplary implementation of this embodiment, the apparatus is further configured to:

switch an aiming direction of the virtual throwable item from the second direction to a fourth direction in response to a direction switching operation for a virtual throwable item after the aiming direction of the virtual throwable item is changed from the first direction to the second direction in response to the first trigger operation for the auxiliary control, the fourth direction being a direction from the first virtual object to a third virtual object in the virtual environment.

The displaying the virtual throwable item being thrown in the second direction in response to a second trigger operation for the release control includes:
display the virtual throwable item being thrown in the third direction in response to the second trigger operation for the release control.

In an exemplary implementation of this embodiment, the switching the aiming direction of the virtual throwable item from the second direction to a fourth direction in response to a direction switching operation for the virtual throwable item includes:
switch the aiming direction of the virtual throwable item from the second direction to the fourth direction in response to a third trigger operation for a sliding control,
where the sliding control is obtained by updating the release control in response to the first trigger operation for the auxiliary control.

In an exemplary implementation of this embodiment, the switching the aiming direction of the virtual throwable item from the second direction to a fourth direction in response to a third trigger operation for a sliding control includes at least one of the following:
switch the aiming direction of the virtual throwable item from the second direction to the fourth direction pointing to the third virtual object on a first side of the second virtual object in response to a first sliding operation for the sliding control; and
switch the aiming direction of the virtual throwable item from the second direction from the second direction to the fourth direction pointing to the third virtual object on a second side of the second virtual object in response to a second sliding operation for the sliding control.

Sliding directions of the first sliding operation and the second sliding operation are opposite.

In an exemplary implementation of this embodiment, the third virtual object includes at least one of the following:
a virtual object associated with a virtual task accepted or selected by the first virtual object;
a virtual object having a historical record of defeating the first virtual object;
a virtual object launching a virtual attack on the first virtual object; and
a virtual object whose moving direction is away from a throwing range of the virtual throwable item.

When the apparatus provided in the foregoing embodiments implements functions of the apparatus, it is illustrated with an example of division of each functional module. In actual applications, the function distribution may be finished by different functional modules according to actual requirements. In other words, an internal structure of a device is divided into different functional modules, to implement all or some of the functions described above.

Specific operation execution manners of the modules in the apparatus in the foregoing embodiments have been described in detail in the embodiments about the method. Technical effects obtained by the modules performing the operation are identical to the technical effects in the method embodiments. Details will not be described herein again.

An embodiment of this application provides a computer device. The computer device includes a processor and a memory. The memory stores a computer program, and the processor is configured to execute the computer program in the memory to implement the method for operating the virtual throwable item in the virtual environment provided in the method embodiments.

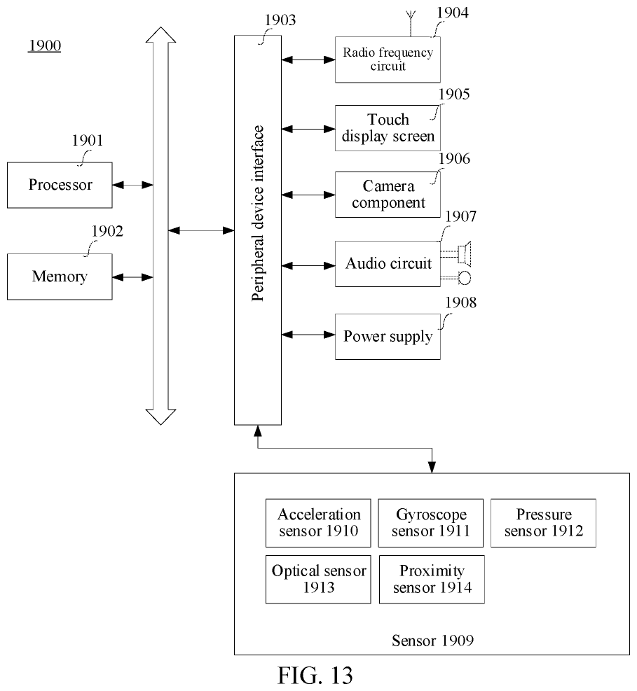

FIG. 13 is a structural block diagram of a terminal according to an exemplary embodiment of this application. The terminal 1900 may be a smartphone, a tablet computer, a moving picture experts group audio layer III (MP3) player, a moving picture experts group audio layer IV (MP4) player, a notebook computer, or a desktop computer. The terminal 1900 may further be referred to as other names such as user equipment, a portable terminal, a laptop terminal, or a desktop terminal.

The terminal 1900 includes a processor 1901 and a memory 1902. The processor 1901 may include one or more processing cores, such as a 4-core processor or an 8-core processor. The processor 1901 may be implemented by using at least one hardware form of digital signal processing (DSP), a field-programmable gate array (FPGA), and a programmable logic array (PLA). The processor 1901 may further include a main processor and a coprocessor. The main processor is a processor configured to process data in a wake-up state, and is further referred to as a central processing unit (CPU). The coprocessor is a low-power-consumption processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an artificial intelligence (AI) processor. The AI processor is configured to process computing operations related to machine learning.

The memory 1902 may include one or more computer-readable storage media. The computer-readable storage medium may be non-transient. The memory 1902 may further include a high-speed random access memory and a nonvolatile memory, for example, one or more disk storage devices or flash storage devices. In some embodiments, the non-transient computer-readable storage medium in the memory 1902 is configured to store at least one instruction. The at least one instruction is configured for being executed by the processor 1901 to implement the method for operating the virtual throwable item in the virtual environment provided in the method embodiments in this application.

In some embodiments, the terminal 1900 may alternatively include: a peripheral device interface 1903 and at least one peripheral device. The processor 1901, the memory 1902, and the peripheral device interface 1903 may be connected through a bus or a signal cable. Each peripheral device may be connected to the peripheral device interface 1903 through a bus, a signal cable, or a circuit board. For example, the peripheral device includes at least one of a radio frequency circuit 1904, a touch display screen 1905, a camera component 1906, an audio circuit 1907, and a power supply 1908.

In some embodiments, the terminal 1900 further includes one or more sensors 1909. The one or more sensors 1909 include, but are not limited to, an acceleration sensor 1910, a gyroscope sensor 1911, a pressure sensor 1912, an optical sensor 1913, and a proximity sensor 1914.

A person skilled in the art may understand that the foregoing structure does not constitute any limitation to the terminal 1900, and the terminal may include more components or fewer components than those shown in the figure, or some components may be combined, or a different component deployment may be used.

In an exemplary embodiment, a chip is further provided, including a programmable logic circuit and/or a program instruction, when running on a computer device, the chip being configured to implement the method for operating the virtual throwable item in the virtual environment provided in the foregoing aspects.

In an exemplary embodiment, a computer program product is further provided. The computer program product includes a computer program, and the computer program is stored in a computer-readable storage medium. A processor of a computer device reads the computer program from the computer-readable storage medium and executes the computer program to implement the method for operating the virtual throwable item in the virtual environment provided in the foregoing method embodiments.

An exemplary embodiment of this application further provides a computer-readable storage medium. The computer-readable storage medium has a computer program stored therein, and the computer program is loaded and executed by a processor to implement the method for operating the virtual throwable item in the virtual environment provided in the foregoing method embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

A person skilled in the art needs to be aware that in the foregoing one or more examples, functions described in the embodiments of this application may be implemented by hardware, software, firmware, or any combination thereof. When implemented by using software, the functions can be stored in a computer-readable medium or can be used as one or more instructions or code in a computer-readable medium for transmission. The computer-readable medium includes a computer storage medium and a communication medium, where the communication medium includes any medium that enables a computer program to be transmitted from one place to another. The storage medium may be any available medium accessible to a general-purpose or dedicated computer.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for operating a virtual throwable item in a virtual environment performed by a computer device, the method comprising:
displaying a first virtual object and a release control of a virtual throwable item in a virtual environment;
displaying an auxiliary control of the virtual throwable item in response to a pre-trigger operation for the release control;
changing an aiming direction of the virtual throwable item from a first direction to a second direction in response to a first trigger operation for the auxiliary control, the second direction being a direction from the first virtual object to a second virtual object in the virtual environment; and
causing the first virtual object to throw the virtual throwable item in the second direction in response to a second trigger operation for the release control.

2. The method according to claim 1, wherein the virtual environment comprises at least two candidate virtual objects including the second virtual object; and
the changing the aiming direction of the virtual throwable item from a first direction to a second direction in response to a first trigger operation for the auxiliary control comprises:
changing the aiming direction of the virtual throwable item from the first direction to the second direction pointing to the second virtual object in response to the first trigger operation for the auxiliary control,
wherein the second virtual object is a virtual object having a minimum distance to the first virtual object among the at least two candidate virtual objects.

3. The method according to claim 2, wherein the changing the aiming direction of the virtual throwable item from the first direction to the second direction pointing to the second virtual object in response to the first trigger operation for the auxiliary control comprises:
propagating a first ray from the first virtual object along the first direction in the virtual environment;
calculating a distance between each candidate virtual object of the at least two candidate virtual objects and the first ray; and
determining the second virtual object based on the respective distances corresponding to the at least two candidate virtual objects, wherein the distance corresponding to the second virtual object is a minimum value of the respective distances corresponding to the at least two candidate virtual objects.

4. The method according to claim 1, wherein the displaying an auxiliary control of the virtual throwable item in response to a pre-trigger operation for the release control comprises:
switching the release control to a wheel control, in response to the pre-trigger operation for the release control, the wheel control being configured to provide a functional entry for changing the aiming direction of the virtual throwable item.

5. The method according to claim 4, wherein the method further comprises at least one of the following:
changing the aiming direction of the virtual throwable item when a drag-and-drop operation on the wheel control does not go beyond the wheel control; and
changing an observation viewing angle of the first virtual object when the drag-and-drop operation on the wheel control goes beyond the wheel control.

6. The method according to claim 1, wherein
when the virtual throwable item is a throwable attack item, the second virtual object and the first virtual object have an adversarial relationship;
when the virtual throwable item is a throwable support item, the second virtual object and the first virtual object have a teammate relationship; and
when the virtual throwable item is a throwable catching item, the second virtual object is a pet virtual object in the virtual environment.

7. The method according to claim 1, wherein the method further comprises:
in response to a direction switching operation on the virtual throwable item, changing the aiming direction of the virtual throwable item from the second virtual object from the second direction to a third direction corresponding to a third virtual object in the virtual environment; and
causing the first virtual object to throw the virtual throwable item in the third direction in response to the second trigger operation for the release control.

8. The method according to claim 7, wherein the changing the aiming direction of the virtual throwable item from the second virtual object from the second direction to a third direction corresponding to a third virtual object in the virtual environment comprises:
switching the aiming direction of the virtual throwable item from the second direction to the third direction in response to a third trigger operation for a sliding control,
wherein the sliding control is obtained by updating the release control in response to a first trigger operation for the auxiliary control.

9. The method according to claim 7, wherein the third virtual object comprises at least one of the following:
a virtual object associated with a virtual task accepted or selected by the first virtual object;
a virtual object having a historical record of defeating the first virtual object;
a virtual object launching a virtual attack on the first virtual object; and
a virtual object whose moving direction is away from a throwing range of the virtual throwable item.

10. A computer device, comprising a processor and a memory, the memory storing at least one section of computer program, and the processor being configured to execute the at least one section of computer program in the memory to implement a method for operating a virtual throwable item in a virtual environment, the method including:
displaying a first virtual object and a release control of a virtual throwable item in a virtual environment;
displaying an auxiliary control of the virtual throwable item in response to a pre-trigger operation for the release control;
changing an aiming direction of the virtual throwable item from a first direction to a second direction in response to a first trigger operation for the auxiliary control, the second direction being a direction from the first virtual object to a second virtual object in the virtual environment; and
causing the first virtual object to throw the virtual throwable item in the second direction in response to a second trigger operation for the release control.

11. The computer device according to claim 10, wherein the virtual environment comprises at least two candidate virtual objects including the second virtual object; and
the changing the aiming direction of the virtual throwable item from a first direction to a second direction in response to a first trigger operation for the auxiliary control comprises:
changing the aiming direction of the virtual throwable item from the first direction to the second direction pointing to the second virtual object in response to the first trigger operation for the auxiliary control,
wherein the second virtual object is a virtual object having a minimum distance to the first virtual object among the at least two candidate virtual objects.

12. The computer device according to claim 11, wherein the changing the aiming direction of the virtual throwable item from the first direction to the second direction pointing to the second virtual object in response to the first trigger operation for the auxiliary control comprises:
propagating a first ray from the first virtual object along the first direction in the virtual environment;
calculating a distance between each candidate virtual object of the at least two candidate virtual objects and the first ray; and
determining the second virtual object based on the respective distances corresponding to the at least two candidate virtual objects, wherein the distance corresponding to the second virtual object is a minimum value of the respective distances corresponding to the at least two candidate virtual objects.

13. The computer device according to claim 10, wherein the displaying an auxiliary control of the virtual throwable item in response to a pre-trigger operation for the release control comprises:
switching the release control to a wheel control, in response to the pre-trigger operation for the release control, the wheel control being configured to provide a functional entry for changing the aiming direction of the virtual throwable item.

14. The computer device according to claim 13, wherein the method further comprises at least one of the following:
changing the aiming direction of the virtual throwable item when a drag-and-drop operation on the wheel control does not go beyond the wheel control; and
changing an observation viewing angle of the first virtual object when the drag-and-drop operation on the wheel control goes beyond the wheel control.

15. The computer device according to claim 10, wherein
when the virtual throwable item is a throwable attack item, the second virtual object and the first virtual object have an adversarial relationship;
when the virtual throwable item is a throwable support item, the second virtual object and the first virtual object have a teammate relationship; and
when the virtual throwable item is a throwable catching item, the second virtual object is a pet virtual object in the virtual environment.

16. The computer device according to claim 10, wherein the method further comprises:
in response to a direction switching operation on the virtual throwable item, changing the aiming direction of the virtual throwable item from the second virtual object from the second direction to a third direction corresponding to a third virtual object in the virtual environment; and
causing the first virtual object to throw the virtual throwable item in the third direction in response to the second trigger operation for the release control.

17. The computer device according to claim 16, wherein the changing the aiming direction of the virtual throwable item from the second virtual object from the second direction to a third direction corresponding to a third virtual object in the virtual environment comprises:
switching the aiming direction of the virtual throwable item from the second direction to the third direction in response to a third trigger operation for a sliding control,
wherein the sliding control is obtained by updating the release control in response to a first trigger operation for the auxiliary control.

18. The computer device according to claim 16, wherein the third virtual object comprises at least one of the following:
a virtual object associated with a virtual task accepted or selected by the first virtual object;
a virtual object having a historical record of defeating the first virtual object;
a virtual object launching a virtual attack on the first virtual object; and
a virtual object whose moving direction is away from a throwing range of the virtual throwable item.

19. A non-transitory computer-readable storage medium, having an executable computer program stored therein, the computer program being loaded and executed by a processor of a computer device and causing the computer device to implement a method for operating a virtual throwable item in a virtual environment including:
displaying a first virtual object and a release control of a virtual throwable item in a virtual environment;
displaying an auxiliary control of the virtual throwable item in response to a pre-trigger operation for the release control;
changing an aiming direction of the virtual throwable item from a first direction to a second direction in response to a first trigger operation for the auxiliary control, the second direction being a direction from the first virtual object to a second virtual object in the virtual environment; and
causing the first virtual object to throw the virtual throwable item in the second direction in response to a second trigger operation for the release control.

20. The non-transitory computer-readable storage medium according to claim 19, wherein the virtual environment comprises at least two candidate virtual objects including the second virtual object; and
the changing the aiming direction of the virtual throwable item from a first direction to a second direction in response to a first trigger operation for the auxiliary control comprises:
changing the aiming direction of the virtual throwable item from the first direction to the second direction pointing to the second virtual object in response to the first trigger operation for the auxiliary control,
wherein the second virtual object is a virtual object having a minimum distance to the first virtual object among the at least two candidate virtual objects.
